(19) United States
(12) Patent Application Publication
(10) Pub. No.: US 2017/0300108 A1
(43) Pub. Date: Oct. 19, 2017

(54) APPLICAITON LOW POWER CONTROL AND THE APPARATUS USING THE SAME

(71) Applicant: MediaTek Inc., Hsin-Chu (TW)

(72) Inventors: Jen-Chieh YANG, Hsinchu City (TW); Shi-Rui LEE, Taoyuan City (TW); Yu-Pin LIN, Zhubei City (TW)

(21) Appl. No.: 15/130,992

(22) Filed: Apr. 17, 2016

(51) Int. Cl. G06F 1/32; G06F 1/28

(52) U.S. Cl. CPC G06F 1/3296; G06F 1/28

(57) ABSTRACT

A power control method including operating a plurality of subsystems of an electronic device according to a software application, measuring power consumption of the subsystems separately, obtaining one or more high power-consuming subsystems for the software application from the subsystems based on the power consumption of the subsystems, and providing a low-power mode with respect to the software application to operate the subsystems with one or more low-power methodologies corresponding to the one or more high power-consuming subsystems.

### BACKGROUND OF THE INVENTION

### Field of the Invention

The present invention relates to application power control of an electronic device comprising multiple subsystems.

### Description of the Related Art

Today, billions of transistors can be squeezed onto a chip. The computing hardware in an electronic device becomes more powerful and functional. A higher hardware resolution or a stronger processing capability may require more power or may considerably increase the temperature of the hardware, which cause existing power or thermal issues to worsen.

Some software applications may also drain excessive amounts of battery power and increase the temperature of the hardware. The battery endurance may be affected by the considerable power consumption of software applications. Also the speed of software applications may slow down because of the thermal problems. In a worse scenario, the computing system may crash.

A novel architecture is required for enhancing the system power management with fewer side effects.

### BRIEF SUMMARY OF THE INVENTION

A power control method in accordance with an exemplary embodiment of the disclosure includes the following steps: operating a plurality of subsystems of an electronic device according to a software application; measuring power consumption of the subsystems separately; obtaining one or more high power-consuming subsystems for the software application from the subsystems based on the power consumption of the subsystems; and providing a low-power mode with respect to the software application to operate the subsystems with one or more low-power methodologies corresponding to the one or more high power-consuming subsystems. The power control method may further provide each subsystem with a power consumption threshold corresponding thereto, and regarding the subsystem exceeding the corresponding power consumption threshold as the power consuming subsystem.

An apparatus with power control in accordance with an exemplary embodiment of the disclosure includes elements for a plurality of subsystems of an electronic device and a power measuring module. The power measuring module measures power consumption of the subsystems separately when the subsystems are operated according to a software application. One or more high power-consuming subsystems for the software application are obtained from the subsystems based on the power consumption of the subsystems. A low-power mode with respect to the software application is provided to operate the subsystems with one or more low-power methodologies corresponding to the one or more high power-consuming subsystems. Each subsystem corresponds to a power consumption threshold and is regarded as the power consuming subsystem when exceeding the power consumption threshold.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram depicting an apparatus with power control in accordance with an exemplary embodiment of the disclosure;

FIG. 2 shows a table 200 listing the power consumption and efficiency penalty information with respect to three different software applications APP1, APP2 and APP3;

FIG. 3 is a chart 300 to be shown on the display 108 to inform the user of the saved power and the aggravated efficiency penalty; and

FIG. 4A and FIG. 4B show a flowchart depicting a power control method in accordance with an exemplary embodiment of the disclosure.

### DETAILED DESCRIPTION OF THE INVENTION

The following description shows exemplary embodiments carrying out the invention. This description is made for the purpose of illustrating the general principles of the invention and should not be taken in a limiting sense. The scope of the invention is best determined by reference to the appended claims.

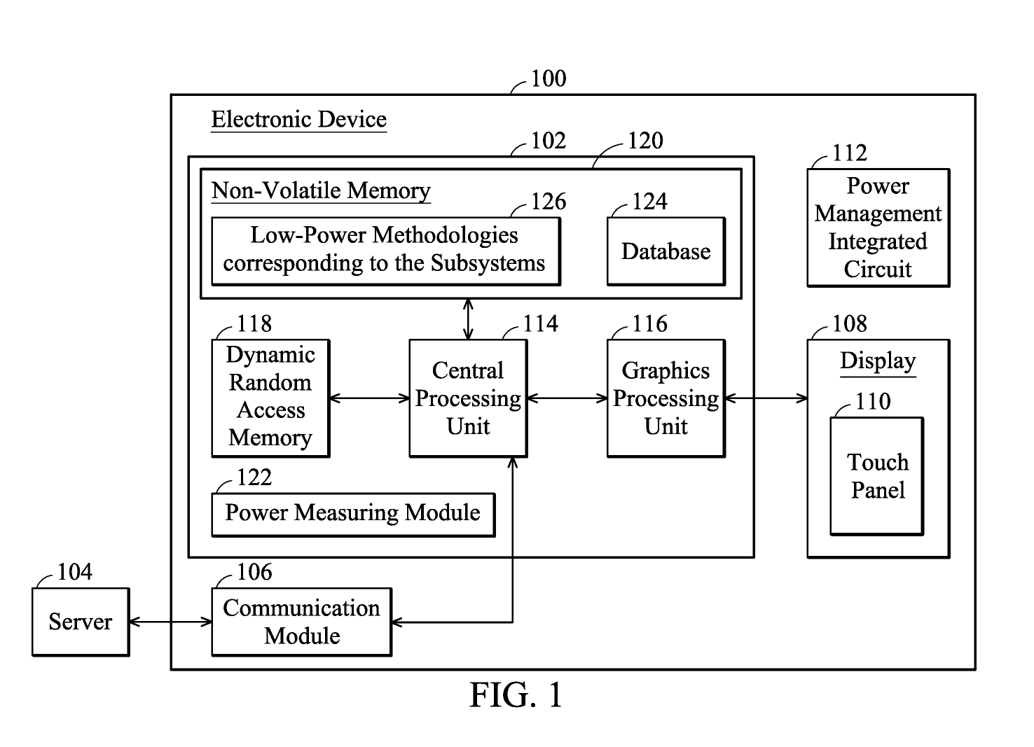

FIG. 1 is a block diagram depicting an apparatus with power control in accordance with an exemplary embodiment of the disclosure. As shown, there is an electronic device 100 in FIG. 1. The disclosed apparatus with power control may comprise at least one portion (e.g. a portion or all) of the electronic device 100. For example, the disclosed apparatus with power control may be a System on Chip (SoC) 102 within the electronic device 100. In another example, the disclosed apparatus with power control may be the whole of the electronic device 100. In another example, the disclosed apparatus with power control may comprise a system comprising the electronic device 100. For example, the disclosed apparatus with power control may be an audio/video system comprising the electronic device 100. In another exemplary embodiment, the disclosed apparatus with power control may include the server 104 as well as the electronic device 100. Examples of the electronic device 100 may include, but are not limited to, a smartphone, a tablet, a wearable device, a personal computer, and so on.

In addition to the SoC 102, the electronic device 100 of FIG. 1 comprises a communication module 106, a display 108 equipped with a touch panel 110 and a power management integrated circuit (PMIC) 112. The SoC 102 coupling to the communication module 106 and the display 108 comprises a central processing unit 114, a graphics processing unit 116, a dynamic random access memory 118, a non-volatile memory 120, and a power measuring module 122. The components on the electronic device 100 are further divided into subsystems whose power consumption is separately measurable by the power measuring module 122. For example, the electronic device 100 may comprise an image display subsystem including the display 108, a touch sensing subsystem including the touch panel 110, a CPU subsystem including the central processing unit 114, a GPU subsystem including the graphics processing unit 116, a DRAM subsystem including the dynamic random access memory 118, and so on. The SoC 102 has elements corresponding to the different subsystems of the electronic device 100 which are not shown in detail in FIG. 1. An apparatus with power control which is the SoC 102 within the electronic device 100 includes the elements corresponding to the different subsystems as well as the power measuring module 122. An apparatus with power control which is the whole electronic device 100 or a system including the electronic device 100 includes the components for the different subsystems as well as the power measuring module 122, wherein the power measuring module 122 is not limited in the SoC 102. In some other exemplary embodiments, the graphics processing unit 116 or/and the dynamic random access memory 118 or/and the non-volatile memory 120 are not integrated in the SoC 102.

The power measuring module 122 measures the power consumption of the subsystems separately when the subsystems are operated according to a software application. The power measuring module 122 may comprise a plurality of power measuring instruments. The power measuring instruments correspond to the subsystems one by one. Each power measuring instrument estimates a power consumption value of the corresponding subsystem. In another exemplary embodiment, the power measuring module 122 comprises power measuring instruments less than the number of subsystems, and the power consumption of the subsystem without a corresponding power measuring instrument is estimated from a power management integrated circuit 112 in addition to the power measuring instruments. For example, the total power supplied to the components on the electronic device 100 may be estimated by the power management integrated circuit 112, and the power consumption of the subsystem without a corresponding power measuring instrument is estimated by subtracting the power consumption measured by the available power measuring instruments from the total power output by the power management integrated circuit 112. Based on the power consumption of the different subsystems, the central processing unit 114 obtains one or more high power-consuming subsystems for the software application from the subsystems and provides a low-power mode with respect to the software application to operate the subsystems with one or more low-power methodologies corresponding to the one or more high power-consuming subsystems. With respect to the software application, the measured power consumption and the obtained high power-consuming subsystem(s) and the corresponding low-power methodology(ies) may be stored to the non-volatile memory 120 to build a database 124. In some exemplary embodiments, each subsystem is provided with a power consumption threshold corresponding thereto. The subsystem exceeding the corresponding power consumption threshold is regarded as a high power-consuming subsystem.

Low-power methodologies corresponding to the subsystems may be stored in the non-volatile memory 120 as number 126. Each low-power methodology may reduce the power consumption of the corresponding subsystem. A low-power methodology for the CPU subsystem may prolong the hot-plug time of the central processing unit 114 (e.g., from 40 ms to 160 ms) or increase the criteria of rising the CPU DVFS (Dynamic Voltage Frequency Scaling), e.g. changing from “rising every time a specific condition is satisfied” to “rising every 5 times the specific condition is satisfied”. A low-power methodology for the GPU subsystem may decrease the GPU DVFS, e.g. from meeting 60 FPS (frame per second) to 30/50 FPS. A low-power methodology for the image display subsystem may reduce the backlight intensity, e.g. from a normal backlight setting to an aggressive display setting (with backlight intensity adaptive to the image contrast). A low-power methodology for the touch sensing subsystem may reduce the touch boost capability (sensitivity to user's touch), e.g., from an enable state to a disable state. A low-power methodology for the DRAM subsystem may reduce the operating frequency. The low-power methodologies 126 corresponding to the different subsystems may be downloaded to the non-volatile memory 120 while firmware updating.

In an exemplary embodiment, when the software application is performed in the low-power mode to operate the high power-consuming subsystem(s) with the low-power methodology(ies), the power measuring module 122 also measures the power consumption of the different subsystems and the central processing unit 114 performs penalty estimation. Then the power consumption measured in the low-power mode and the corresponding penalty estimation are provided for a trade-off between saved power and aggravated efficiency penalty. With respect to the software application, the power consumption measured in the low-power mode and the efficiency penalty estimated from the penalty estimation may be also stored to the non-volatile memory 120 into the database 124. The saved power and the aggravated efficiency penalty of the low-power mode of the software application may be edited into a chart and shown on the display 108 and, accordingly, the user of the electronic device 100 can decide whether to select the low-power mode to execute the software application or not.

In FIG. 1, the electronic device 100 further communicates with the server 104 to manage big data in the server 104. With respect to a software application, the big data comprises one or more of the following: the power consumption measured in a normal-power mode (without using any of the low-power methodologies), the high power-consuming subsystem(s), the low-power methodology(ies) corresponding to the high power-consuming subsystem(s), the power consumption measured in the low-power mode, and the efficiency penalty estimated from penalty estimation. The big data with respect to the software application is downloaded from the server 104 when the software application is downloaded to install or update on the electronic device 100. The downloaded big data may update the database 124.

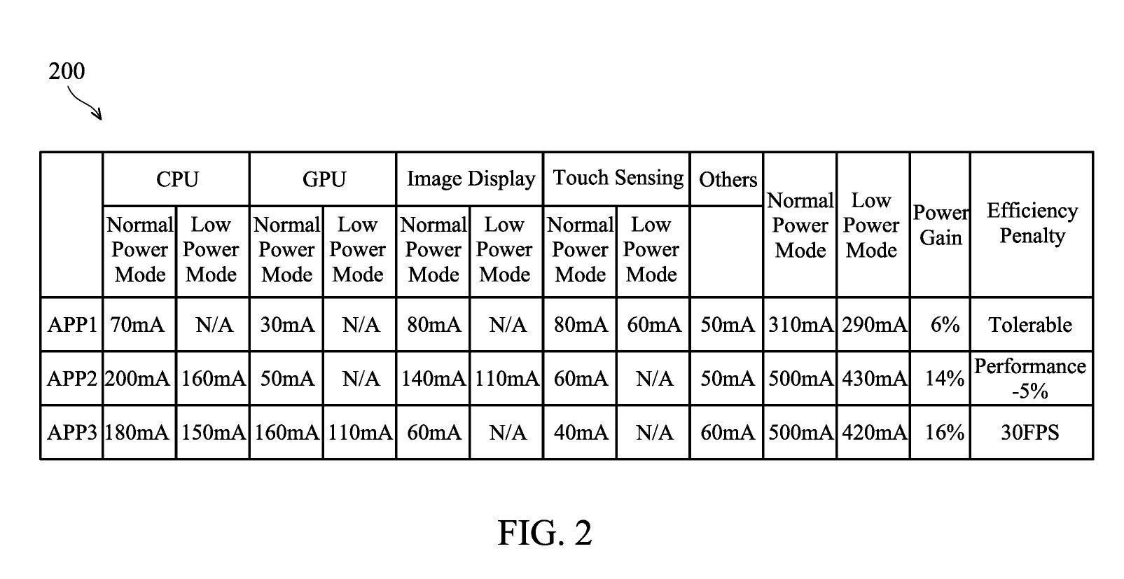

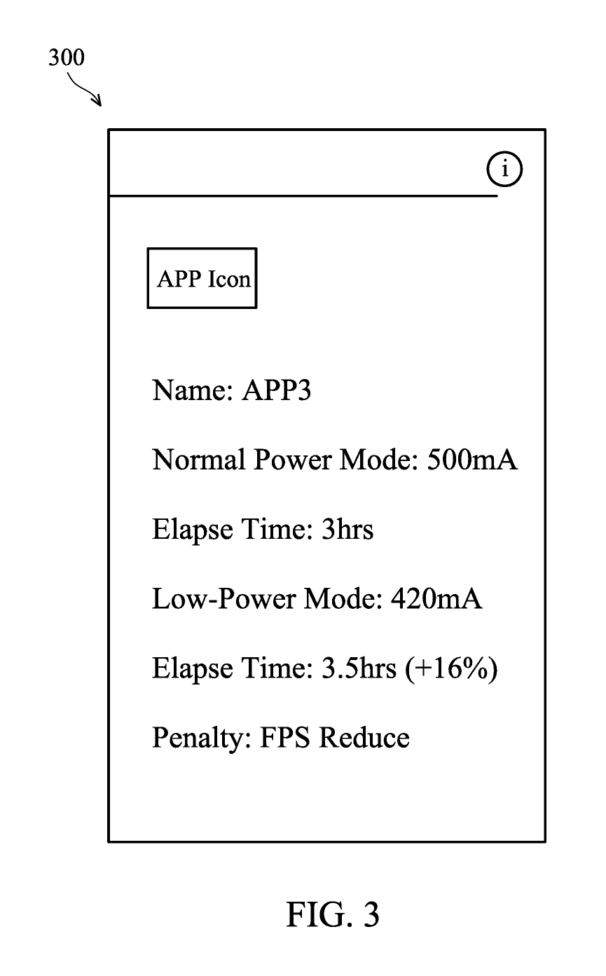

FIG. 2 shows a table 200 listing the power consumption and efficiency penalty information with respect to three different software applications APP1, APP2 and APP3. The column “Others” is obtained from subtracting the power consumption measured by the available power measuring instruments from the total power output by the power management integrated circuit 112. For software application APP1, the touch sensing subsystem with power consumption over the corresponding threshold is regarded as a high power-consuming subsystem and a low-power methodology reducing the power consumption of the touch sensing subsystem (from 80 mA to 60 mA) is applied, the result is a power gain of 6% and tolerable efficiency penalty. For software application APP2, the CPU subsystem with power consumption over the corresponding power consumption threshold and the image display subsystem with power consumption over the corresponding power consumption threshold both are regarded as high power-consuming subsystems and a low-power methodology reducing the power consumption of the CPU subsystem (from 200 mA to 160 mA) and a low-power methodology reducing the power consumption of the image display subsystem (from 140 mA to 110 mA) are applied, resulting to a power gain of 14% and a reduced performance (−5%) efficiency penalty. For software application APP3, the CPU subsystem with power consumption over the corresponding power consumption threshold and the GPU subsystem with power consumption over the corresponding power consumption threshold both are regarded as high power-consuming subsystems and a low-power methodology reducing the power consumption of the CPU subsystem (from 180 mA to 150 mA) and a low-power methodology reducing the power consumption of the GPU subsystem (from 160 mA to 110 mA) are applied, resulting to a 16% power gain and a reduced frame rate (down to 30 FPS) as the efficiency penalty. The power gain and the efficiency penalty corresponding to a recalled software application may be recorded into a chart to be shown on the display 108 and, accordingly, the user of the electronic device 100 can decide whether to select the low-power mode to execute the recalled software application or to persist in using the normal-power mode to execute the recalled software application. FIG. 3 is an exemplary chart 300 to be shown on the display 108 so that the user knows the saved power and the aggravated efficiency penalty. The chart 300 may be provided by the User Interface of the recalled software application to help the user to select the normal- or lower-power mode.

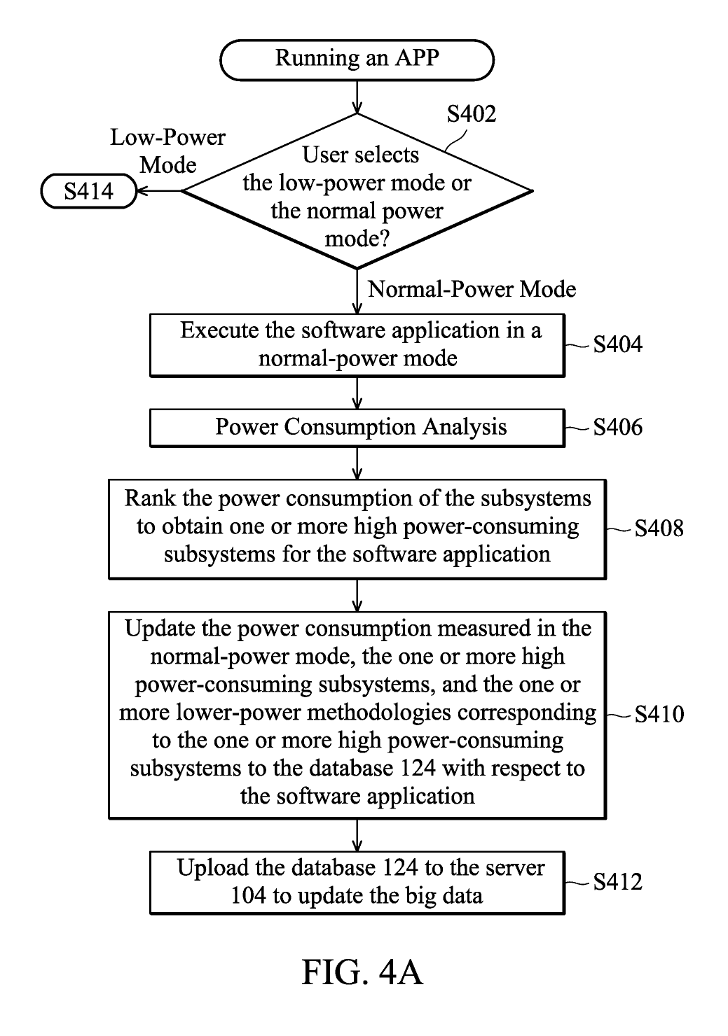

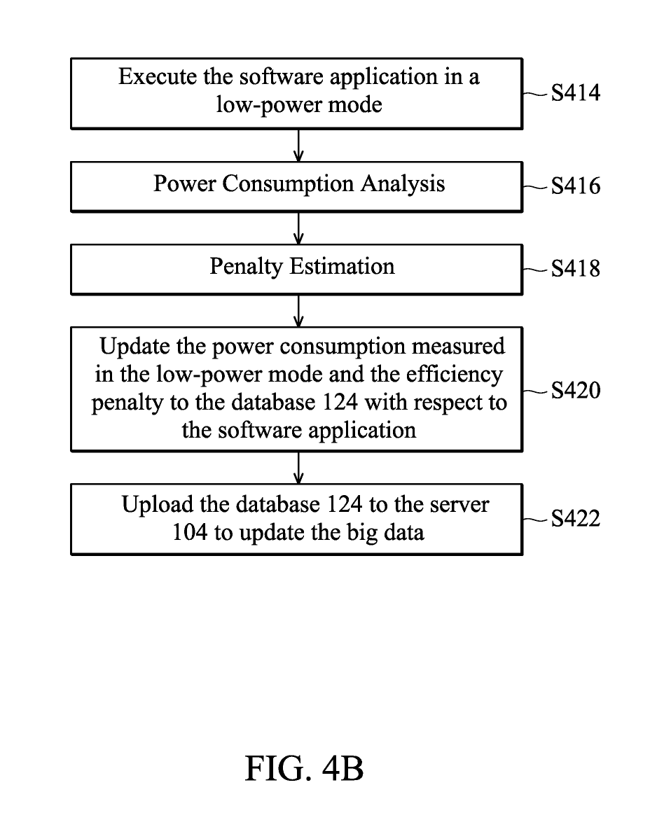

FIG. 4A and FIG. 4B together show a flowchart depicting a power control method in accordance with an exemplary embodiment of the disclosure. For a software application (APP)run for the first time, the corresponding big data is downloaded from the server 104 to the non-volatile memory 120 as the database 124 when the software application is downloaded to install or update on the electronic device 100. In another case wherein the software application has been run on the electronic device 100, the database 124 is maintained according to the previous execution history of the software application. In step S402, a chart like the one shown in FIG. 3 is displayed on the display 108 for the user to decide whether to select the low-power mode to execute the software application. If the user chose not to enter the low-power mode, step S404 is performed to execute the software application in a normal-power mode without using any low-power methodologies. In step S406, the power measuring module 122 is operated for power consumption analysis, to measure power consumption of the subsystems of the electronic device 100 separately. In step S408, one or more high power-consuming subsystems for the software application are obtained from the subsystems based on the power consumption of the subsystems. The power consumption measured in the normal-power mode, the one or more high power-consuming subsystems, and the one or more low-power methodologies corresponding to the one or more high power-consuming subsystems are updated to the database 124 with respect to the software application in step S410 and are uploaded to the server 104 to update the big data in step S412. When the user selects to execute the software application in the low-power mode, step S414 of FIG. 4B is performed. In step S414, the software application is performed in a lower-power mode in which the subsystems are operated with one or more low-power methodologies corresponding to the one or more high power-consuming subsystems. In step S416, the power measuring module 122 is operated for power consumption analysis, to measure power consumption of the subsystems of the electronic device 100 separately. In step S418, penalty estimation is performed. The power consumption measured in the low-power mode and the efficiency penalty are updated to the database 124 with respect to the software application in step S420 and are uploaded to the server 104 to update the big data in step S422.

In some other exemplary embodiments, the database 124 is not uploaded to the server 104 to manage the big data and is exclusively maintained for the electronic device 100. In such cases, the first time running a software application is generally in a normal-power mode without using any low-power methodologies for the different subsystems of the electronic device 100.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power control method, comprising:
operating a plurality of subsystems of an electronic device according to a software application;
measuring power consumption of the subsystems;
obtaining one or more high power-consuming subsystems for the software application from the subsystems based on the power consumption of the subsystems; and
providing a low-power mode with respect to the software application to operate the subsystems with one or more low-power methodologies corresponding to the one or more high power-consuming subsystems.

2. The power control method as claimed in claim 1, further comprising:
storing low-power methodologies corresponding to the subsystems in a non-volatile memory.

3. The power control method as claimed in claim 1, further comprising:
providing each subsystem with a power consumption threshold corresponding thereto; and
regarding the subsystem exceeding the corresponding power consumption threshold as the high power-consuming subsystem.

4. The power control method as claimed in claim 1, wherein:
when the software application is performed in the low-power mode, the power consumption of the different subsystems is also measured and penalty estimation is performed, for trade-off between saved power and aggravated efficiency penalty.

5. The power control method as claimed in claim 4, further comprising:
communicating with a server to manage big data in the server, wherein, with respect to the software application, the big data comprises the power consumption measured in a normal-power mode, the one or more high power-consuming subsystems, the one or more low-power methodologies corresponding to the one or more high power-consuming subsystems, the power consumption measured in the low-power mode, and efficiency penalty estimated from the penalty estimation.

6. The power control method as claimed in claim 5, wherein:
the big data with respect to the software application is downloaded from the server when the software application is downloaded to install or update on the electronic device, for the trade-off between the saved power and the aggravated efficiency penalty.

7. The power control method as claimed in claim 6, further comprising:
using a user interface to assist user of the electronic device selecting between the normal-power mode and the low-power mode.

8. The power control method as claimed in claim 1, further comprising:
providing a plurality of power measuring instruments corresponding to the subsystems one by one.

9. The power control method as claimed in claim 1, further comprising:
providing a plurality of power measuring instruments, wherein the number of power measuring instruments is less than the number of subsystems; and
estimating the power consumption of the subsystem without a corresponding power measuring instrument from a power management integrated circuit and the power measuring instruments.

10. An apparatus with power control, comprising:
elements for a plurality of subsystems of an electronic device; and
a power measuring module, measuring power consumption of the subsystems separately when the subsystems are operated according to a software application,
wherein:
one or more high power-consuming subsystems for the software application are obtained from the subsystems based on the power consumption of the subsystems; and
a low-power mode with respect to the software application is provided to operate the subsystems with one or more low-power methodologies corresponding to the one or more high power-consuming subsystems.

11. The apparatus as claimed in claim 10, wherein:
low-power methodologies corresponding to the subsystems are stored in a non-volatile memory.

12. The apparatus as claimed in claim 10, wherein:
each subsystem corresponds to a power consumption threshold and is regarded as the high power-consuming subsystem when exceeding the power consumption threshold.

13. The apparatus as claimed in claim 10, wherein:
when the software application is performed in the low-power mode, the power measuring module also measures the power consumption of the different subsystems and penalty estimation is performed, for trade-off between saved power and aggravated efficiency penalty.

14. The apparatus as claimed in claim 13, communicating with a server to manage big data in the server, wherein, with respect to the software application, the big data comprises the power consumption measured in a normal-power mode, the one or more high power-consuming subsystems, the one or more low-power methodologies corresponding to the one or more high power-consuming subsystems, the power consumption measured in the low-power mode, and efficiency penalty estimated from the penalty estimation.

15. The apparatus as claimed in claim 14, wherein:
the big data with respect to the software application is downloaded from the server when the software application is downloaded to install or update on the electronic device, for the trade-off between the saved power and the aggravated efficiency penalty.

16. The apparatus as claimed in claim in claim 15, wherein:
the big data is shown on a display of the electronic device by a user interface, for selection between the normal-power mode and the low-power mode.

17. The apparatus as claimed in claim 10, wherein:
the power measuring module comprises a plurality of power measuring instruments corresponding to the subsystems one by one.

18. The apparatus as claimed in claim 10, wherein:
the power measuring module comprises a plurality of power measuring instruments, and the number of power measuring instruments is less than the number of subsystems; and
the power consumption of the subsystem without a corresponding power measuring instrument is estimated from a power management integrated circuit and the power measuring instruments.
